(19) United States
(12) Patent Application Publication
(10) Pub. No.: US 2026/0027518 A1
(43) Pub. Date: Jan. 29, 2026

(54) SOURCE GAS CONDUIT WITH SORBENT COATING FOR ADSORBING GASES FROM GAS STREAM, WITH RELATED METHOD

(71) Applicant: GE INFRASTRUCTURE TECHNOLOGY LLC, Greenville, SC (US)

(72) Inventors: Ewald FREITAG, Baden (CH); Andre THEUER, Baden (CH); Fernando BIAGIOLI, Fislisbach (CH); Khawar Jamil SYED, Oberrohrdorf (CH); Teresa MARCHIONE, Baden (CH)

(21) Appl. No.: 19/139,099

(22) PCT Filed: Dec. 20, 2022
(86) PCT No.: PCT/US2022/081997

§ 371 Date: Jun. 13, 2025

(51) Int. Cl. B01D 53/62; B01D 53/82; B01D 53/96

(52) U.S. Cl. CPC B01D 53/62; B01D 53/82; B01D 53/96; B01D 2253/3425; B01D 2257/504; B01D 2259/40088

(57) ABSTRACT

Embodiments of the disclosure provide an apparatus having a source gas conduit with a sorbent coating to adsorb compounds from a gas stream, and related methods. An apparatus of the disclosure includes a heat exchanger having an interior configured to transmit a heat exchange medium. A plurality of source gas conduits is in thermal communication with the heat exchanger and configured to transmit a gas stream therethrough. Each of the plurality of source gas conduits is in thermal communication with the heat exchanger. A sorbent coating is on an interior sidewall of each of the plurality of source gas conduits.

### TECHNICAL FIELD

The disclosure relates generally to adsorbing of compounds from a gas, and more particularly, to an apparatus and method for using a source gas conduit with a sorbent coating to adsorb one or more compounds from a gas stream.

### BACKGROUND

Power generation systems, also known as power plants, typically include a variety of different systems (e.g., turbomachine, generator, and/or other interconnected assemblies) that are used to generate power. Power plants may include a power source (e.g., a turbomachine, solar panel, nuclear reactor, etc.), a prime mover (e.g., a rotatable shaft or similar element) for coupling the power source to an electric generator, and/or various components of the electric generator. For instance, a power generation system may include a gas turbine assembly having a compressor coupled to a gas turbine. The gas turbine in turn may be coupled to and drive a generator mounted on the same shaft. The generator produces power.

Gaseous exhaust from a power generation system, as well as other types of gas streams, may include various gaseous compounds, e.g., emissions, that cannot be released into and/or remain within the environment above predetermined limits. Various devices and/or substances have proven operable to reduce the concentration of emissions from gas streams. However, some types of emissions (e.g., greenhouse gases) have proven especially difficult to remove from a gas stream. Such difficulties may be prevalent where the reaction conditions needed for extracting such emissions are difficult to create due to the temperatures and/or other conditions typically present within structures for carrying a gas stream.

### BRIEF DESCRIPTION

All aspects, examples and features mentioned below can be combined in any technically possible way.

An aspect of the disclosure provides an apparatus including: a heat exchanger having an interior configured to transmit a heat exchange medium therethrough; a plurality of source gas conduits in thermal communication with the heat exchanger and configured to transmit a gas stream therethrough, wherein each of the plurality of source gas conduits is in thermal communication with the heat exchanger; and a sorbent coating on an interior sidewall of each of the plurality of source gas conduits.

Another aspect of the disclosure includes any of the preceding aspects, and wherein the sorbent coating adsorbs carbon dioxide (CO₂) from the gas stream within the plurality of source gas conduits.

Another aspect of the disclosure includes any of the preceding aspects, and wherein the plurality of source gas conduits extends in parallel with the heat exchanger and surrounds the heat exchanger.

Another aspect of the disclosure includes any of the preceding aspects, and wherein at least one of the plurality of source gas conduits is free of contact with the heat exchanger.

Another aspect of the disclosure includes any of the preceding aspects, and wherein each of the plurality of source gas conduits has a honeycomb shape.

Another aspect of the disclosure includes any of the preceding aspects, and wherein a diameter of the heat exchanger is larger than a separation distance between a pair of opposite sidewalls in each of the plurality of source gas conduits, and is smaller than a separation distance between a pair of opposite vertices in each of the plurality of source gas conduits.

Another aspect of the disclosure includes any of the preceding aspects, and further including: an additional heat exchanger adjacent the plurality of source gas conduits and configured to transmit the heat exchange medium therethrough; and a connecting passage fluidly coupling the heat exchanger to the additional heat exchanger.

An aspect of the disclosure provides an apparatus including: a gas path for transmitting a gas stream from a power generation system to an external environment; a plurality of heat exchangers within the gas path and having an interior configured to transmit a heat exchange medium; a plurality of source gas conduits within the gas path coupled to an exterior of one of the plurality of heat exchangers and configured to transmit the gas stream therethrough, wherein each of the plurality of source gas conduits is in thermal communication with at least one of the plurality of heat exchangers and extends substantially in parallel with the plurality of heat exchangers; and a plurality of interior sidewalls within at least one the plurality of source gas conduits, each of the plurality of interior sidewalls having a sorbent coating thereon, wherein the sorbent coating is configured to adsorb a compound from the gas stream.

Another aspect of the disclosure includes any of the preceding aspects, and wherein the compound includes carbon dioxide (CO₂).

Another aspect of the disclosure includes any of the preceding aspects, and wherein at least one of the plurality of source gas conduits is free of contact with the plurality of heat exchangers.

Another aspect of the disclosure includes any of the preceding aspects, and wherein the plurality of interior sidewalls defines a honeycomb shape.

Another aspect of the disclosure includes any of the preceding aspects, and wherein a diameter of each of the plurality of heat exchangers is larger than a separation distance between a pair of opposite sidewalls in each of the plurality of source gas conduits, and is smaller than a separation distance between a pair of opposite vertices in each of the plurality of source gas conduits.

Another aspect of the disclosure includes any of the preceding aspects, and further including at least one connecting passage fluidly coupling two of the plurality of heat exchangers.

Another aspect of the disclosure includes any of the preceding aspects, and wherein a ratio of source gas conduits to heat exchangers within the gas path is between approximately 1:1 and approximately 100:1.

An aspect of the disclosure provides a method including: transmitting a heat exchange medium through an interior of a heat exchanger; and transmitting a gas stream through a plurality of source gas conduits in thermal communication with the heat exchanger, wherein each of the plurality of source gas conduits is in thermal communication with the heat exchanger such that the heat exchange medium affects a temperature of a sorbent coating within the plurality of source gas conduits, wherein the transmitted gas stream reacts with the sorbent coating within each of the plurality of source gas conduits to adsorb a compound from the gas stream.

Another aspect of the disclosure includes any of the preceding aspects, and further including: transmitting a low-temperature fluid through the heat exchanger such that the sorbent coating adsorbs the compound from the gas stream; and transmitting a high-temperature fluid through the heat exchanger to desorb the compound from the sorbent coating for extraction from a gas path.

Another aspect of the disclosure includes any of the preceding aspects, and wherein the compound includes carbon dioxide (CO₂).

Another aspect of the disclosure includes any of the preceding aspects, and further including coupling one of a heating fluid supply or a cooling fluid supply to the heat exchanger.

Another aspect of the disclosure includes any of the preceding aspects, and further comprising coupling the plurality of source gas conduits to an exterior sidewall of the heat exchanger.

Another aspect of the disclosure includes any of the preceding aspects, and further including coupling the plurality of source gas conduits and the heat exchanger to an interior of a gas path from a power generation system.

Two or more aspects described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 illustrates a cross-sectional view of a gas path in an apparatus according to embodiments of the disclosure;

FIG. 2 illustrates a perspective view of a plurality of source gas conduits in an apparatus according to embodiments of the disclosure;

FIG. 3 illustrates a partial cross-sectional view of a plurality of source gas conduits and heat exchangers according to embodiments of the disclosure;

FIG. 4 depicts a magnified perspective view of a plurality of source gas conduits and heat exchangers according to embodiments of the disclosure;

FIG. 5 depicts a perspective view of a source gas conduit and a plurality of heat exchangers according to embodiments of the disclosure;

FIG. 6 depicts a cross-sectional view of heat exchangers being provided within source gas conduits according to further embodiments of the disclosure;

FIG. 7 depicts an example of a four-to-one configuration of source gas conduits and heat exchangers according to further embodiments of the disclosure;

FIG. 8 depicts an example of an eight-to-one configuration of source gas conduits and heat exchangers according to further embodiments of the disclosure;

FIG. 9 depicts an example of another four-to-one configuration of source gas conduits and heat exchangers according to additional embodiments of the disclosure;

FIG. 10 depicts another example configuration in which a larger number of heat exchangers are provided than heat exchangers according to embodiments of the disclosure; and

FIGS. 11A and 11B depict various alternate arrangements of heat exchangers and source gas conduits according to still further embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the subject matter of the current disclosure, it will become necessary to select certain terminology when referring to and describing relevant machine objects within an additive manufacturing system. To the extent possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular object may be referred to using several different or overlapping terms. What may be described herein as being a single part may include and be referenced in another context as consisting of multiple parts. Alternatively, what may be described herein as including multiple parts may be referred to elsewhere as a single part.

Several descriptive terms may be used regularly herein, as described below. The terms “first,” “second,” and “third” may be used interchangeably to distinguish one object from another and are not intended to signify location or importance of the individual objects.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or objects but do not preclude the presence or addition of one or more other features, integers, steps, operations, elements, objects, and/or groups thereof. “Optional” or “optionally” means that the subsequently described event or circumstance may or may not occur or that the subsequently described object or element may or may not be present, and that the description includes instances where the event occurs, or the object is present and instances where it does not or is not present.

Where an element or layer is referred to as being “on,” “engaged to,” “connected to” or “coupled to” another element or layer, it may be directly on, engaged to, connected to, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

As indicated above, the disclosure provides an apparatus having source gas conduit with a sorbent coating to adsorb compounds from a flow of gas (e.g., a gas stream, a volume of contacted air, etc.) and related methods. More specifically, the apparatus may include a heat exchanger having an interior configured to transmit a heat exchange medium. The heat exchanger includes a thermally conductive material. A plurality of source gas conduits is in thermal communication with the heat exchanger and configured to transmit gas stream therethrough. Each of the plurality of source gas conduits is in thermal communication with the heat exchanger. A sorbent coating is on an interior sidewall of each of the plurality of source gas conduits.

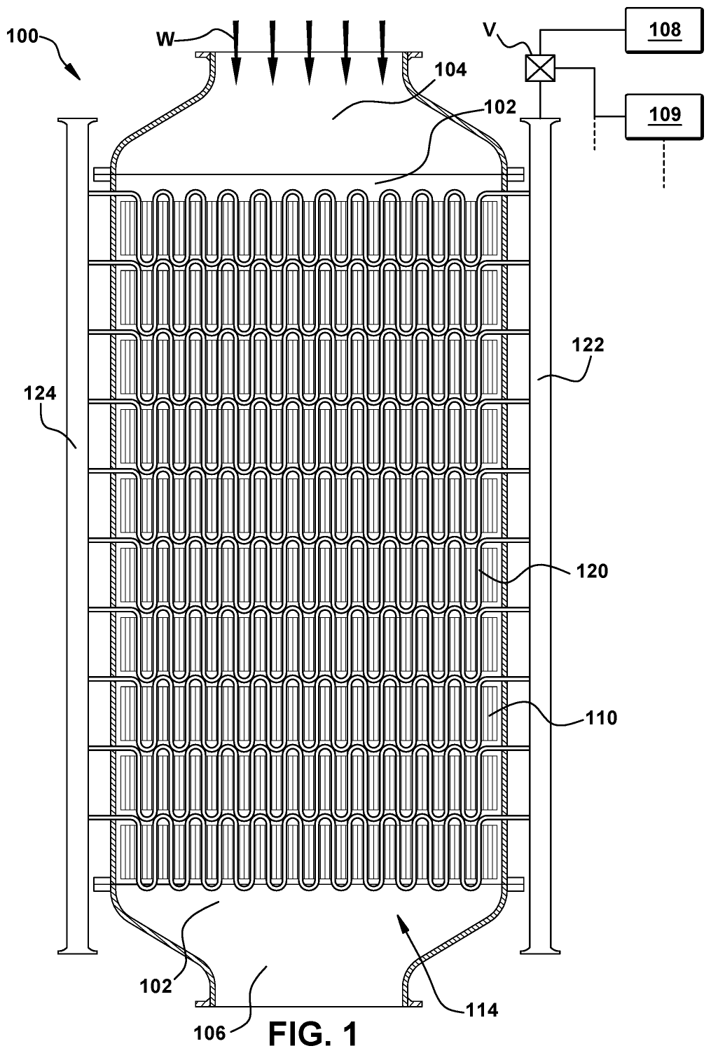

Referring to FIG. 1, embodiments of the disclosure provide an apparatus 100 including a gas path 102 for transmitting a gas stream W (e.g., from a power generation system) to an external environment (e.g., ambient space and/or other areas external to power generation components). Gas stream W may include any flow of gas, including those produce by or unrelated to to power generation system operation. In some examples, gas stream W may be gas(es) produced from a power generation reaction (e.g., combustion to power a gas-driven turbomachine and/or other power generation device such as such as stack gas, exhaust gas, emissions, etc., and/or other gases unrelated). In other gases, gas stream W may be a flow of air or may include gases produced from other sources (e.g., flue gases from a production plant). Gas stream W may contain compounds such as the reaction products of fuel and combustion air and residual material(s), e.g., sulfur oxides, nitrogen oxides (NO_{X}), carbon monoxide (CO) and/or carbon dioxide (CO₂), and any particulates expelled from a reaction zone. Reaction products in gas stream W of particular interest include, e.g., carbon-based emissions (e.g., carbon dioxide CO₂) and/or other gaseous products that must be controlled within applicable limits. Gaseous products, however, may be difficult to remove from gas stream W under typical operating conditions unless the temperature is adjusted to an acceptable level for driving reactions to remove targeted gases. Embodiments of apparatus 100 provide physical space for driving adsorption of gases from gas stream W and simultaneously controlling the temperature within gas path 102 to allow continuous adsorption regardless of operating conditions.

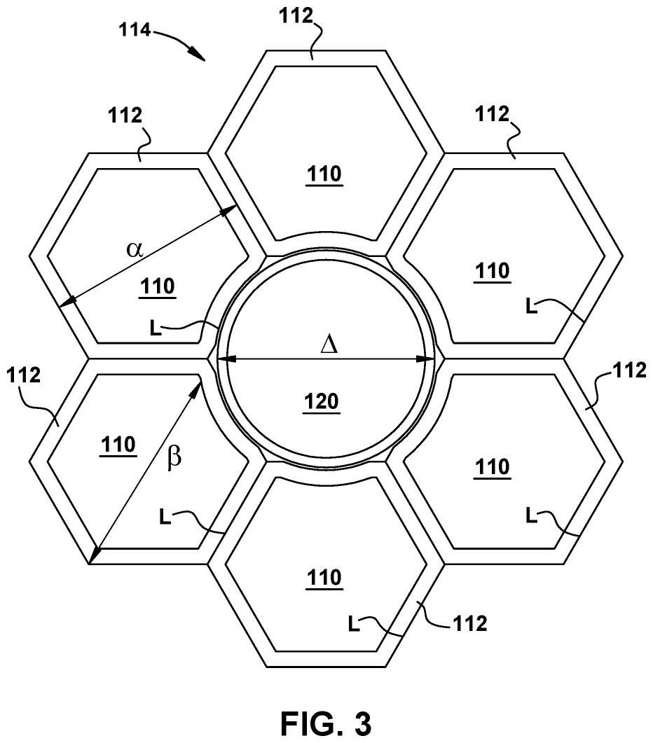

Gas stream W may enter gas path 102 through an inlet 104 (e.g., a space having predetermined dimensions suitable to a corresponding power generation system(s)) and may exit gas path 102 through an outlet 106 connected to an external environment (e.g., ambient space and/or any other component(s) external to a power generation system). Portions of apparatus 100 also may be adjacent or fluidly coupled to a heating fluid supply 108 and/or a cooling fluid supply 109 external to gas path 102. Fluid supplies 108, 109 may provide heat exchange media for adjusting the temperature within gas path 102 as discussed elsewhere herein. Gas path 102, between inlet 104 and outlet 106, may include and/or be subdivided into a plurality of source gas conduits 110. The term “source gas” refers to the composition of gas stream W as it enters gas path 102. Source gas, by this definition, includes compounds to be adsorbed via embodiments of apparatus 100. The term “released gas” refers to the composition of gas stream W as it exits gas path 104. Released gas differs from source gas by having a significantly lower concentration of targeted compounds (e.g., CO₂ or other substances noted herein) due to these compounds being adsorbed in apparatus 100. Each source gas conduit 110 may extend substantially in parallel with the orientation of gas path 102 between inlet 104 and outlet 106. Thus, source gas conduits 110 may extend substantially in parallel with each other. As discussed in further detail herein, source gas conduits 110 may include a sorbent coating 112 (FIG. 3) that is physically exposed to gas stream W as it passes from inlet 104 to outlet 106 through gas path 102. As noted herein, sorbent coating 112 may include a solid layer of adsorbing materials, catalysts, etc., configured for adsorbing a compound such as CO₂ from a gas stream. Source gas conduits 110 may be manufactured to be as thin as possible and may include one or more metals capable of being formed and processed as thin sheets of material. According to an example, each source gas conduit 110 may be formed of metallic sheets having a thickness of at most approximately forty micrometers (μm), such that the cross-sectional area of source gas conduit 110 (i.e., including the open space that it surrounds) is between approximately 1.7% metal and approximately 5.9% metal. Each source gas conduit 110 may have any conceivable length, e.g., they may extend through a majority of gas path 102 and/or may be subdivided into multiple source gas conduits 110 linearly spaced throughout gas path 102.

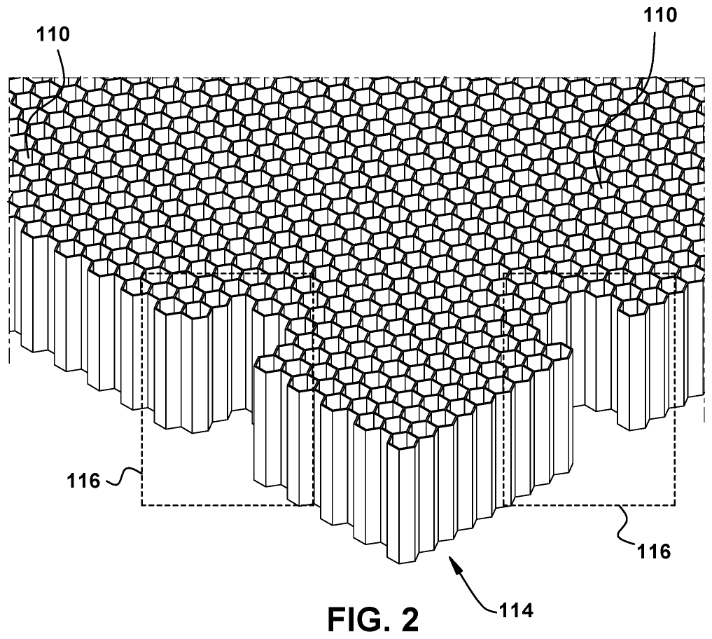

Referring to FIGS. 1 and 2 together, in which FIG. 2 provides an expanded view of a source gas conduit bank 114 within gas path 102, further details of source gas conduits 110 are described. Source gas conduits 110 may have any desired cross-sectional geometry for providing open space for passage of gas stream W therethrough. According to various embodiments, source gas conduits 110 may have any conceivable geometry, e.g., rounded, triangular, quadrilateral, and/or any polygonal shape for enclosing an area. FIG. 2, as an example, illustrates each source gas conduit 110 in conduit bank 114 as being hexagonal. Source gas conduits 110 may be adjacent one or more other source gas conduits 110 of conduit bank 114 of the same shape, e.g., they are shaped and sized to fit together. In this example, source gas conduits 110 of source gas conduit bank 114 form a honeycomb-type pattern. Some portions of source gas conduit bank 114 may not include source gas conduits 110, thus defining openings 116 within source gas conduit bank 114. As discussed in further detail herein, openings 116 provide empty space between source gas conduits 110 of source gas conduit bank 114 to provide thermally conducting structures, e.g., heat exchangers 120 (FIG. 1, FIG. 3 et seq.) discussed herein.

Referring to FIGS. 1 and 3, a group of heat exchangers 120 may be provided within apparatus 100 and may extend throughout source gas conduit bank(s) 114 within gas path 102. Each heat exchanger 120 may include a thermally conductive material of sufficient strength, thickness, etc., to prevent any heat-transmitting fluids (e.g., heating fluid(s), refrigerant(s), etc.) from physically intermixing with gas stream W as it passes through source gas conduits 110. Source gas conduits 110 may be shaped and/or may be of a sufficiently low thickness to deform and adapt to the outer diameter of heat exchanger(s) 120 in the case where conduits 110 and heat exchangers 120 have different geometries. In various examples, heat exchanger(s) 120 may include one or more metal(s) suitable for use as a fluid and thermal transmitting medium, e.g., aluminum (Al), copper (Cu), and/or other heat transmitting metals or alloys. Heat exchangers 120 may extend in parallel with source gas conduit(s) 110 within source gas conduit bank 114. Source gas conduits 110 may be coupled to the exterior of heat exchanger(s) 120, e.g., by way of brazing and/or other metallic bonding techniques to maintain thermal contact between adjacent conduits 110 and heat exchangers 120. As shown in FIG. 1, and discussed in further detail herein, heat exchangers 120 may change direction and thus may include one or more bends for passing through conduit bank 114 multiple times. Portions of heat exchanger(s) 120 within gas path 104 may be free of distributor and/or collector assemblies to prevent significant pressure loss within heat exchanger(s) 120 as the heat exchange medium passes therethrough. In other implementations, heat exchanger(s) 120 may include distribution and/or collection manifolds that are within gas path 102 and located between groups of source gas conduits 110.

Additionally, as shown in FIG. 3 and discussed elsewhere herein, each heat exchanger 120 may be adjacent multiple source gas conduits 110 to provide heating or cooling to multiple source gas conduits 110 of conduit bank 114 simultaneously.

Heat exchanger(s) 120 may be coupled to an exchange medium line 122 (FIG. 1 only) to a discharge line 124 (FIG. 1 only), e.g., in different locations external to gas path 102 and/or heat exchanger(s) 120. Lines 122, 124 may be the sole distributing and collecting mechanisms for heat exchanger(s) 120 and may be located outside gas path 104 as discussed herein. Exchange medium line 122 may be supplied with one or more fluids having a higher temperature than gas stream W as it enters inlet 104 (i.e., where heating is desired), or one or more fluids having a lower temperature than gas stream W as it enters inlet 104 (i.e., where cooling is desired). To provide a heat exchange medium to exchange medium line 122, apparatus 100 may include a heating fluid supply 108 and/or a cooling fluid supply 109 coupled to exchange medium line 122. Fluid supplies 108, 109 may be coupled to exchange medium line 122, e.g., via one or more valves V for selectively providing a heat exchange medium of a desired temperature to exchange medium line 122. As shown, exchange medium line 122 may be alternately coupled to multiple distinct fluid supplies 108 for heating or cooling fluids that may be selectively coupled to heat exchanger(s) 120, e.g., using a control system including adjustable valves, computing devices and mechanical couplings for selecting one or more valves (e.g., valve V) to open or close, etc. Additional fluid supplies 108, 109 optionally may be coupled to exchange medium line 122 as indicated with dashed lines in FIG. 1.

As a heat exchange medium travels through heat exchanger(s) 120 from exchange medium line 122 to discharge line 124, its temperature may change due to thermal communication with gas stream W in source gas conduit(s) 110. Thus, the heat exchange medium may reach discharge line 124 at a different temperature than its initial temperature within exchange medium line 122. Discharge line 124 may be coupled to an external environment (e.g., ambient and/or other portions of a larger system in need of heating or cooling), depending on the function of heat exchange media (i.e., heating or cooling) transmitted through heat exchanger(s) 120.

As shown in FIG. 3, a portion of conduit bank 114 may include several source gas conduits 110 adjacent one heat exchanger 120, e.g., with source gas conduits 110 placed circumferentially about heat exchanger 120. Each source gas conduit 110 may include an interior sidewall L that has sorbent coating 112 thereon. Sorbent coating 112 may include, e.g., one or more metal-organic frameworks (MOF), amine-based solid coatings configured to adsorb carbon dioxide and/or similar compounds, zeolites, and/or any other currently known or currently known sorbent material for capturing targeted gas(es) from gas stream W. MOFs and/or zeolites, in particular, may be suitable for adsorbing CO2 from gas stream W. Sorbent coating 112 of each source gas conduit 110, however, may be non-reactive with gas stream W at the exhaust's temperature when passing through inlet 104 of gas path 102. To induce adsorption of gas(es) from gas stream W, heat exchanger 120 may raise or lower the temperature of source gas conduit(s) 110 such that sorbent coating(s) 112 are of a desired temperature to adsorb, and thus remove, certain gas(es) from gas stream W. The adsorbed compound(s) in sorbent coating(s) 112 can subsequently be desorbed for extraction from gas path 102. In the case where adsorption of CO₂ is desired, heat exchanger 120 may transmit a heat exchange medium of lower temperature than the initial temperature of gas stream W as it passes through inlet 104. Thus, heat exchanger 120 is operable to reduce the temperature of gas stream W within source gas conduit(s) 110 and thus induce sorbent coating(s) 112 (e.g., MOFs, zeolites, etc.) to react with and adsorb CO₂ from exhaust gas stream W. Sorbent coating(s) 112 are not explicitly shown on source gas conduit(s) 110 in other figures solely for clarity of illustration; any source gas conduit 110 of any configuration discussed herein may have sorbent coating(s) 112 on its interior sidewall(s).

To increase thermal communication between heat exchanger 120 and source gas conduit(s) 110, heat exchanger 120 may be shaped according to various specifications. In the case where source gas conduit(s) 110 of conduit bank 114 define a substantially hexagonal “honeycomb” arrangement, as shown in FIG. 3, each heat exchanger 120 may be directly adjacent six source gas conduits 110. Furthermore, heat exchanger 120 may be in thermal communication with additional source gas conduits 110 that are not directly adjacent thereto, as discussed herein. Heat exchanger 120 may feature a diameter A that is larger than a separation distance a between opposite sidewalls L in each source gas conduit 110. However, diameter D of heat exchanger 120 may be smaller than a separation distance β between opposite vertices (i.e., the junctions between two sidewalls L) in each source gas conduit 110. Separation distances α and β, relative to each other, may vary such that separation distance β is equal to approximately 1.15 times separation distance α, or is related by a factor of similar scale. Applicant has determined that shaping heat exchanger(s) 120 in this manner significantly increases heat transfer to immediately adjacent source gas conduits 110 as well as other source gas conduits 110 of source gas conduit bank 114 that are not directly adjacent heat exchanger 120.

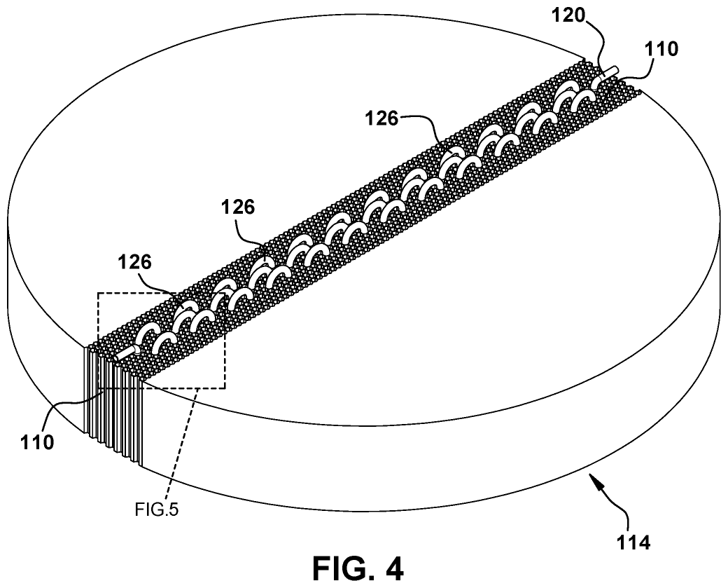

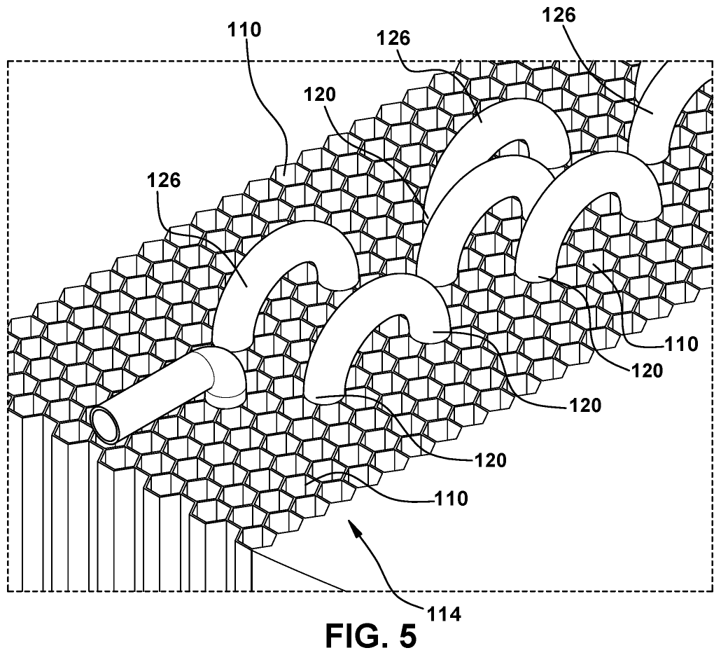

Referring to FIGS. 4 and 5, in which FIG. 4 depicts a portion of conduit bank 114 (portions thereof obscured for ease of illustration) and FIG. 5 depicts a magnified view of conduit bank 114, further aspects of source gas conduits 110 and heat exchangers 120 are discussed. As shown, some source gas conduits 110 of source gas conduit bank 114 may be free of contact with any heat exchangers 120. Such source gas conduits 110 nevertheless may be in thermal communication with heat exchanger(s) 120 through any intervening source gas conduits 110, i.e., because source gas conduit(s) 110 may be formed of a heat-conductive material, as discussed herein.

To reduce the number of source gas conduit(s) 110 that are free of contact with heat exchanger(s) 120 and/or to improve thermal communication within source gas conduit bank 114, one or more heat exchangers 120 may include return or connecting passages 126. Connecting passages 126 may include, e.g., bends and/or other segments extending non-perpendicularly relative to source gas conduits 110 to recirculate heat exchange media through source gas conduit bank 114 multiple times. The number of connecting passages 126 may depend on several factors, e.g., the maximum span of heat exchanger 120 within source gas conduit bank 114 and/or gas path 102. The heat exchanger(s) 120 joined via connecting passage(s) 126 may be considered to be additional heat exchanger(s) 120 and/or different portions of the same heat exchanger 120, depending on context and/or differences in temperature. In various implementations, each heat exchanger 120 may pass through source gas conduit bank 114 six times or more. In further implementations, and/or in other portions of one source gas conduit bank 114, other heat exchangers 120 may pass through source gas conduit bank 114 only one time, or any applicable number of times.

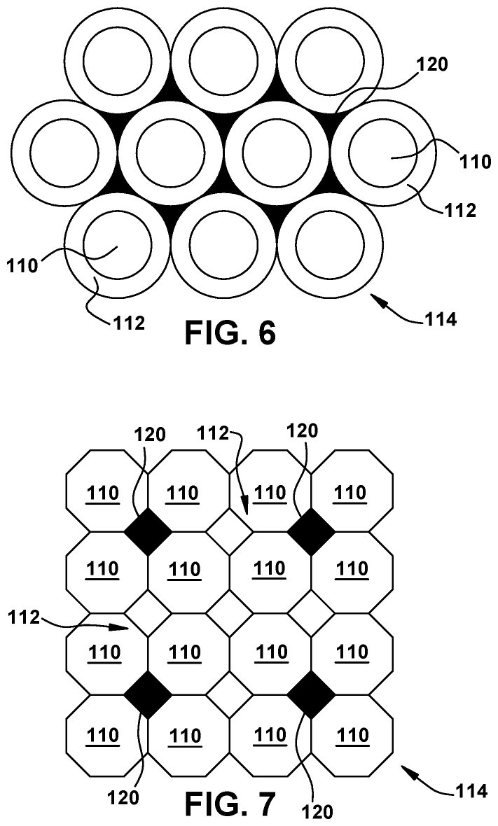

FIG. 6 depicts an example of source gas conduit bank 114 according to still further embodiments of the disclosure. Although source gas conduits 110 and heat exchangers 120 are discussed and illustrated as occupying different spaces within source gas conduit bank 114 elsewhere herein, this is not necessarily required in all instances. Here, heat exchanger(s) 120 may occupy the space between source gas conduit(s) 110, i.e., the non-circular empty spaces illustrated in FIG. 6. Here, heat exchanger(s) 120 may be in thermal communication with the exterior(s) of source gas conduit 110 while also being in thermal communication with each other via exterior sidewalls of source gas conduit 110. This arrangement may be particularly suitable for cases where heat exchanger(s) 120 need to adjust the temperature of source gas conduit(s) 110 in source gas conduit bank 114 quickly. In still further embodiments, the position of source gas conduit(s) 110 and heat exchanger(s) 120 may be reversed such that source gas conduit(s) 110 occupy the space between adjacent heat exchanger(s) 120.

FIG. 7 depicts a further alternative to the honeycomb configuration shown in FIGS. 2-4, e.g., in which the ratio of source gas conduits 110 to heat exchangers is approximately four-to-one instead of being six-to-one as described above (e.g., in the honeycomb configuration). These physical aspects of source gas conduits 110 may be varied to tune the ratio of source gas conduits 110 to heat exchangers 120, and/or the amount of cross-sectional area occupied by source gas conduits 110 and heat exchangers 120 relative to each other. In this case, source gas conduit(s) 110 may be substantially octagonal and only one sidewall of each source gas conduit 110 may be adjacent a corresponding heat exchanger 120. By this arrangement, heat exchanger(s) 120 may be omitted from the quadrilateral space between certain source gas conduit(s) 110 while being present in this space elsewhere within source gas conduit bank 114. The quadrilateral spaces not occupied by heat exchangers 120 may or may not become source gas conduits 110 with sorbent coating 112.

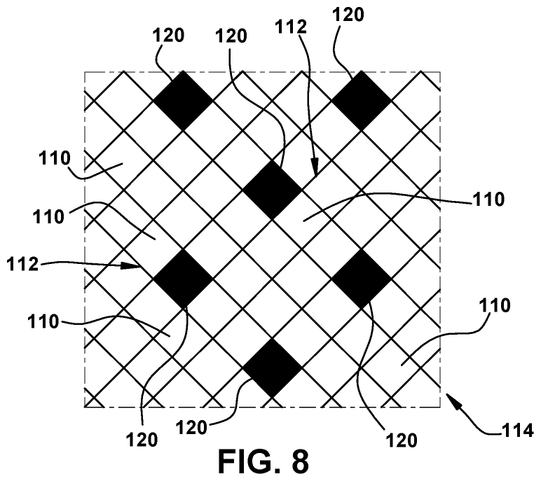

FIG. 8 depicts a further configuration of conduit bank 114 capable of being implemented in embodiments of the disclosure. In this example, source gas conduits 110 and heat exchangers 120 within conduit bank 114 may have a ratio of approximately eight-to-one. To provide this configuration, each conduit 110, 120 optionally may be of the same or substantially similar cross-sectional area. Moreover, conduits 110 and heat exchangers 120 may be substantially square or otherwise in a quadrilateral shape such that each heat exchanger 120 is surrounded by a corresponding group of source gas conduits 110 (e.g., eight source gas conduits 110 as shown). The eight-to-one configuration of conduits 110 and heat exchangers 120 may be particularly useful in cases where the temperature of gas path 102 (FIG. 1) is high enough that a lower amount of heating or cooling via heat exchangers 120 is required.

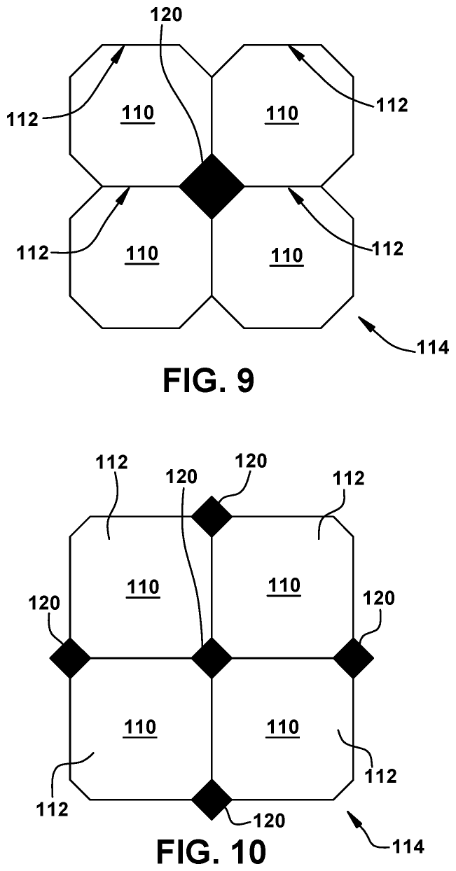

Turning to FIG. 9, another configuration of conduit bank 114 may provide source gas conduits 110 and heat exchangers 120 in another tunable ratio, e.g., four-to-one. Here, heat exchanger 120 may be quadrilateral (e.g., square shaped) whereas source gas conduits 110 may be substantially octagonal (non-equilateral). Heat exchanger 120, may be adjacent four source gas conduits 110 on all four of its sides, whereas source gas conduits 110 may be adjacent other source gas conduits 110 on some sides but adjacent heat exchanger(s) 120 on other sides. Additionally, source gas conduits 110 may have a larger cross-sectional area than heat exchanger 120. Source gas conduits 110 in this case may transmit more fluid therethrough than the adjacent heat exchanger(s) 120. As compared to the above-noted examples shown in FIG. 7, the ratio of source gas conduit 110 size to heat exchanger 120 size may increase from the implementation of FIG. 7 to FIG. 8 and to FIG. 9, thus adding an additional degree of freedom to influence the heat transfer behavior. Embodiments of the disclosure allow a manufacturer to select a heat exchanger pattern ratio in a wide range, e.g., between approximately 1:1 and approximately 100:1. Heat exchanger(s) 120 may remain operable to heat or cool multiple source gas conduits 110 simultaneously due to being surrounded by four source gas conduits 110. The ratio of source gas conduits 110 to heat exchangers 120 may be adjusted in this situation, e.g., by providing additional heat exchangers 120 in other spaces between source gas conduits 110, thus reducing the ratio of source gas conduits 110 to heat exchangers 120. Embodiments of conduit bank 114 as depicted in FIG. 8. or similar configurations, may be especially suitable to finely adjust the heating or cooling of source gas conduits 110, e.g., by modifying the number of heat exchangers 120 within conduit bank 114 by including or omitting heat exchangers 120 in various positions.

FIG. 10 depicts yet another configuration in which heat exchangers 120 may have a smaller cross-sectional area than source gas conduits 110, but in which heat exchangers 120 outnumber source gas conduits, e.g., to further adjust the ratio of space occupied by source gas conduits 110 to space occupied by heat exchangers 120. FIG. 10 in particular illustrates a configuration where the ratio of source gas conduits 110 to heat exchangers 120 is approximately four-to-five.

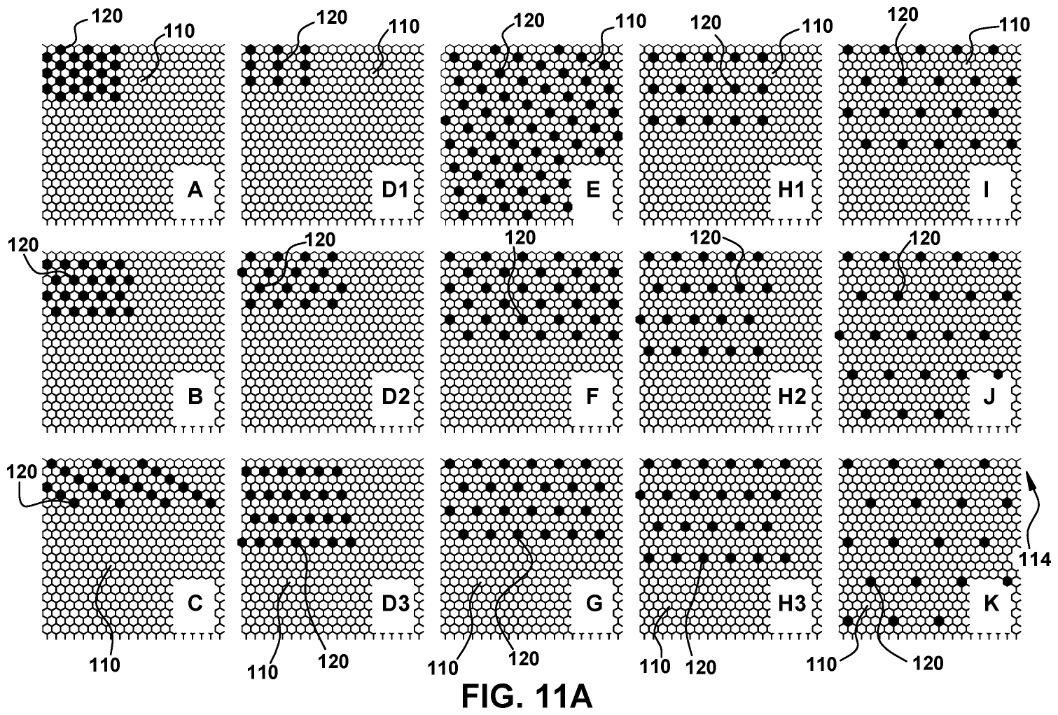

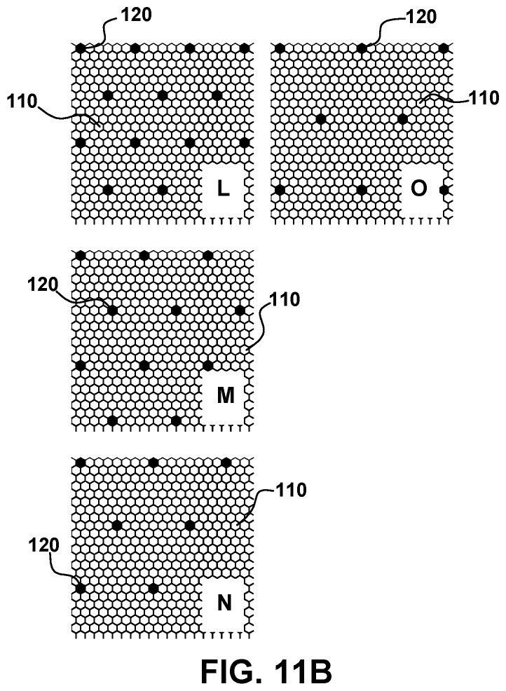

FIGS. 11A and 11B depict a variety of alternate configurations for conduit bank 114, e.g., allowing variation in the ratio of source gas conduits 110 to heat exchangers 120. The illustrated examples are separately identified with reference signs A, B, C, D1, D2, D3, E, F, G, H1, H2, H3, I, J, K, L, M, N and O. Conduits 110 and heat exchangers 120 in each of the examples are shown as having a honeycomb shape, but this is not necessarily required. One or more of these example configurations, and/or other arrangements of conduits 110 and heat exchangers 120 may be implemented in conduit bank(s) 114 to provide different amounts of thermal conductivity between conduits 110 and heat exchangers 120. Example A shows an approximately two-to-one ratio of source gas conduits 110 to heat exchangers 120. Example B shows an approximately three-to-one ratio of source gas conduits 110 to heat exchangers 120. Example C shows an approximately four-to-one ratio of source gas conduits 110 to heat exchangers 120, in which heat exchangers 120 are arranged as diagonal lines within conduit bank 114. Examples D1-D3 illustrate varying types of a five-to-one ratio of source gas conduits to heat exchangers 120, in which heat exchangers 120 may be arranged in horizontally or vertically extending linear arrays (i.e., examples D1, D3) or may be uniformly dispersed throughout conduit bank 114 (i.e., example D2). Examples E, F, G, each depict a 6:1, 7:1, and 8:1 ratio of source gas conduits 110 to heat exchangers 120 in varying configurations. Examples H1-H3 similarly depict various examples of source gas conduits 110 and heat exchangers 120 in ratios of approximately eleven-to-one. Examples I, J, K, L, M, N and O depict still further arrangements in which source gas conduits 110 and heat exchangers are in a ratio of 15:1, 19:1, 24:1 35:1, 48:1, 63:1 and O=80:1. Higher amounts of source gas conduits 110 relative to heat exchangers 120 accommodate larger amounts of exhaust gas in conduit bank 114 but lower amounts of heat exchange, whereas lower amounts of source gas conduits 110 relative to heat exchangers 120 accommodate less exhaust gas in conduit bank 114 but higher amounts of heat exchange. Fewer source gas conduits 110 per heat exchangers 120, moreover, may reduce the number of source gas conduits 110 that are structurally separated from heat exchanger(s) 120 by other source gas conduits 110.

Referring again to FIGS. 1 and 3, embodiments of the disclosure provide a method for adsorbing one or more gases from gas stream W, e.g., using any one or more of the various implementations of apparatus 100 discussed herein. A method according to the disclosure may include, e.g., transmitting a heat exchange medium through heat exchanger(s) 120, such that the thermally conductive composition of heat exchanger(s) 120 affects (i.e., raises or lowers) the temperature of gas stream W within source gas conduit(s) 110. The transmitting of a heat exchange medium through heat exchanger(s) 120 may include, e.g., connecting heat exchanger(s) 120 to one of several exchange medium supplies 122, each having a heating fluid or cooling fluid to be transmitted through heat exchanger(s) 120 such that a desired temperature is obtained. In some cases, methods of the disclosure may include coupling source gas conduit bank(s) 114 to an interior of gas path 102 (e.g., between inlet 104 and outlet 106 thereof) such that source gas conduit(s) 110 are positioned to adsorb gas(es) from gas stream W.

Upon reaching a desired temperature of gas stream W within source gas conduit(s) 110. the method may include transmitting gas stream W through any (or all) source gas conduits 110 that are in thermal communication with heat exchanger(s) 120. In some cases, methods of the disclosure may include physically coupling source gas conduit(s) 110 to an exterior of heat exchanger(s) 120 such that conduit(s) 110, 120 are in thermal communication with each other. Source gas conduit(s) 110 being in thermal communication with heat exchanger(s) 120 will affect the temperature of sorbent coating(s) 112 (shown in FIG. 3 only), so they may react with gas stream W to adsorb one or more gases therefrom. When sorbent coating(s) 112 reach a desired temperature by operation of heat exchanger(s) 120 and the heat exchange medium transmitted therethrough. sorbent coating(s) 112 may react with gas stream W to adsorb any compound(s) (e.g., CO₂) that are capable of being adsorbed using sorbent coating(s) 112. For instance, heat exchanger(s) 120 may cool sorbent coating(s) 112 such that CO₂ or other compounds are adsorbed from gas stream W and thus captured within sorbent coating(s) 112. At a later time, gas path 102 may be coupled to a receptacle for CO₂ and/or other space for releasing CO₂ from sorbent coating 112. At this time, sorbent coating(s) 112 may be heated via heat exchanger(s) 120, such that the captured CO₂ is desorbed from sorbent coating(s) 112 and removed from gas path 102.

Embodiments of the disclosure provide various technical and commercial advantages, examples of which are discussed herein. Embodiments of apparatus 100 can substantially improve adsorption of particular contaminants in a variety of gas path(s) 102, including those of a power generation system, e.g., by eliminating the need for a separate pressure vessel and/or other structure to adsorb certain types of emissions. By providing source gas conduit(s) 110 and heat exchanger(s) 120 directly within gas path 102, embodiments of the disclosure may reduce reactor volume by up to approximately fifty percent (e.g., approximately 3500) cubic meters) when implemented in a power generation system. This benefit, in turn, may reduce reactor weight by up to approximately eighty percent (e.g., approximately 1000 tons). These benefits also may reduce power needed to heat or cool portions of a power generation system by up to approximately thirty megawatts. These and other benefits are achievable, e.g., by maintaining strong physical and thermal coupling between conduits 110 and heat exchangers 120 during operation and/or a flow of appropriate heat exchange media through heat exchangers 120.

The foregoing drawings show some of the processing associated according to several embodiments of this disclosure. The acts noted in the drawings or description may occur out of the order noted or, for example, may in fact be executed substantially concurrently or in the reverse order, depending upon the act involved. Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately,” as applied to a particular value of a range, applies to both end values and, unless otherwise dependent on the precision of the instrument measuring the value, may indicate +/−5% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application and to enable others of ordinary skill in the art to understand the disclosure for various embodiments with various modifications as are suited to the particular use contemplated.

1. An apparatus comprising:
a heat exchanger having an interior configured to transmit a heat exchange medium therethrough;
a plurality of source gas conduits in thermal communication with the heat exchanger and configured to transmit a gas stream therethrough, wherein each of the plurality of source gas conduits is in thermal communication with the heat exchanger; and,
a sorbent coating on an interior sidewall of each of the plurality of source gas conduits.

2. The apparatus of claim 1, wherein the sorbent coating adsorbs carbon dioxide from the gas stream within the plurality of source gas conduits.

3. The apparatus of claim 1, wherein the plurality of source gas conduits extends in parallel with the heat exchanger and surrounds the heat exchanger

4. The apparatus of claim 1, wherein at least one of the plurality of source gas conduits is free of contact with the heat exchanger.

5. The apparatus of claim 1, wherein each of the plurality of source gas conduits has a honeycomb shape.

6. The apparatus of claim 1, wherein a diameter of the heat exchanger is larger than a separation distance between a pair of opposite sidewalls in each of the plurality of source gas conduits, and is smaller than a separation distance between a pair of opposite vertices in each of the plurality of source gas conduits.

7. The apparatus of claim 1, further comprising:
an additional heat exchanger adjacent the plurality of source gas conduits and configured to transmit the heat exchange medium therethrough; and,
a connecting passage fluidly coupling the heat exchanger to the additional heat exchanger.

8. An apparatus comprising:
a gas path for transmitting a gas stream from a power generation system to an external environment;
a plurality of heat exchangers within the gas path and having an interior configured to transmit a heat exchange medium;
a plurality of source gas conduits within the gas path coupled to an exterior of one of the plurality of heat exchangers and configured to transmit the gas stream therethrough, wherein each of the plurality of source gas conduits is in thermal communication with at least one of the plurality of heat exchangers and extends substantially in parallel with the plurality of heat exchangers; and,
a plurality of interior sidewalls within at least one of the plurality of source gas conduits, each of the plurality of interior sidewalls having a sorbent coating thereon, wherein the sorbent coating is configured to adsorb a compound from the gas stream.

9. The apparatus of claim 8, wherein the compound includes carbon dioxide.

10. The apparatus of claim 8, wherein at least one of the plurality of source gas conduits is free of contact with the plurality of heat exchangers.

11. The apparatus of claim 8, wherein the plurality of interior sidewalls defines a honeycomb shape.

12. The apparatus of claim 8, wherein a diameter of each of the plurality of heat exchangers is larger than a separation distance between a pair of opposite sidewalls in each of the plurality of source gas conduits, and is smaller than a separation distance between a pair of opposite vertices in each of the plurality of source gas conduits.

13. The apparatus of claim 8, further comprising at least one connecting passage fluidly coupling two of the plurality of heat exchangers.

14. The apparatus of claim 8, wherein a ratio source gas conduits to heat exchangers within the gas path is between approximately 1:1 and approximately 100:1.

15. A method comprising:
transmitting a heat exchange medium through an interior of a heat exchanger; and,
transmitting a gas stream through a plurality of source gas conduits in thermal communication with the heat exchanger, wherein each of the plurality of source gas conduits is in thermal communication with the heat exchanger such that the heat exchange medium affects a temperature of a sorbent coating within the plurality of source gas conduits
wherein the transmitted gas stream reacts with the sorbent coating within each of the plurality of source gas conduits to adsorb a compound from the gas stream

16. The method of claim 15, further comprising:
transmitting a low-temperature fluid through the heat exchanger such that the sorbent coating adsorbs the compound from the gas stream; and,
transmitting a high-temperature fluid through the heat exchanger to desorb the compound from the sorbent coating for extraction from a gas path.

17. The method of claim 15, wherein the compound includes carbon dioxide.

18. The method of claim 15, further comprising coupling one of a heating fluid supply or a cooling fluid supply to the heat exchanger.

19. The method of claim 15, further comprising coupling the plurality of source gas conduits to an exterior sidewall of the heat exchanger.

20. The method of claim 18, further comprising coupling the plurality of source gas conduits and the heat exchanger to an interior of a gas path.
